(19) United States
(12) Patent Application Publication
(10) Pub. No.: US 2025/0218197 A1
(43) Pub. Date: Jul. 3, 2025

(54) METHOD FOR OPERATING A DELIVERY VEHICLE

(71) Applicant: Ford Global Technologies, LLC, Dearborn, MI (US)

(72) Inventors: Mathijs Lens, Leuven (BE); Pieter Robberechts, Leuven (BE); Turgay Isik Aslandere, Aachen (DE); Mark Gijbels, Kessel-lo (BE); Wannes Meert, Leuven (BE); Jesse Davis, Leuven (BE); Toon Goedemé, Leuven (BE); Patrick Vandewalle, Leuven (BE)

(73) Assignee: Ford Global Technologies, LLC, Dearborn, MI (US)

(21) Appl. No.: 18/985,457

(22) Filed: Dec. 18, 2024

(30) Foreign Application Priority Data
Dec. 27, 2023 (DE) 102023136728.5

(51) Int. Cl. G06V 20/59; G06Q 10/0833; G06T 7/70

(52) U.S. Cl. CPC G06V 20/59; G06Q 10/0833; G06T 7/70; G06T 2207/30268

(57) ABSTRACT

The disclosure relates to the operation of a delivery vehicle, including the steps of generating a reference image dataset of a package, analyzing the reference image dataset in order to determine an ident dataset for the package, and temporarily storing the ident dataset, generating a partial image dataset of the package in the delivery vehicle, determining a spatial location dataset that is indicative of a spatial location of the package, analyzing the partial image dataset using the spatial location dataset allocation dataset for the package comparing the allocation dataset with the ident dataset in order to reidentify the package.

### CROSS-REFERENCE TO RELATED APPLICATIONS

The present application claims priority to and the benefit of German Application No. 102023136728.5, filed on Dec. 27, 2023, which is hereby incorporated by reference herein in its entirety.

### FIELD

The invention relates to a method for operating a delivery vehicle, to a computer program product configured to carry out such a method, to a system for operating such a delivery vehicle, and to a delivery vehicle for such a system.

### BACKGROUND

Packages, for example parcels from a delivery service, are delivered to customers by means of a delivery vehicle, such as a delivery van. Various studies have shown that, when a package is delivered, the last kilometer gives rise to more than 50% of the total shipping costs. The bulk of the costs arise in the delivery vehicle during loading and unloading of the packages.

Delivery is in many cases not automated. For example, in the distribution center, a delivery agent scans all the packages manually by means of a handset, such as a barcode reader, and loads them into the delivery vehicle. Then, during the delivery phase, the delivery agent must locate the correct package in the delivery vehicle. This is time-consuming and results in lower efficiency of the delivery, which in turn gives rise to higher costs.

### SUMARY

An object of the disclosure is to show ways in which improvements can be achieved here.

Another object of the disclosure is achieved by a method for operating a delivery vehicle, comprising the steps:
generating a reference image dataset of a package,
analyzing the reference image dataset to determine an ident dataset for the package, and temporarily storing the ident dataset,
generating a partial image dataset of the package in the delivery vehicle,
determining a spatial location dataset that is indicative of a spatial location of the package,
analyzing the partial image dataset using the spatial location dataset to determine an allocation dataset for the package,
comparing the allocation dataset with the ident dataset to identify the package.

Accordingly, in a first step, images of all the side faces of the package, that is to say of all six side faces of a parcel having a cuboidal basic shape, are recorded in a distribution center of a delivery service by means of one or more cameras and are stored temporarily as a reference image dataset.

In a further step, the reference image dataset so formed is analyzed in the distribution center to determine an ident dataset for each side face of the package. The ident dataset is a machine-readable binary data string, which encodes the data of the reference image dataset. The ident dataset for the package can be generated from the reference image dataset using a trained Siamese neural network, which will be explained in detail below. The reference image dataset can be analyzed in a cloud, it is transferred to the cloud before being analyzed. However, in a departure therefrom, the reference image dataset can also be analyzed in the distribution center or in the delivery vehicle.

The package is then loaded into the delivery vehicle and the ident dataset is stored temporarily in a cloud or in the delivery vehicle. This can be affected at different times, that is to say in succession, or also at the same time. The delivery vehicle then leaves the distribution center with the package.

The partial image dataset of side faces of the package is then generated in the delivery vehicle by means of cameras in the load space of the delivery vehicle, for example while the delivery vehicle is traveling to a recipient. However, image data are not recorded of all the side faces of the package but only of, for example, two or three side faces.

The partial image dataset is then analyzed to determine first the spatial location of the package, that is to say its orientation in space, and then the allocation dataset for the package. The allocation dataset, like the ident dataset, is a machine-readable binary data string, which encodes the data of the partial image dataset. The allocation dataset for the package is generated from the partial image dataset using the same trained Siamese neural network as was used to generate the ident dataset in the distribution center.

The allocation dataset is then compared with the ident dataset to reidentify the package. In other words, if there is, for example, a plurality of packages in the delivery vehicle, the respective allocation datasets are compared with the respective ident datasets to determine those pairs that best match one another.

The method thus allows the respective package to be identified based on the partial image dataset by comparison with a reference image dataset. In other words, use is made of the fact that only part of the data that were used for the initial identification is necessary for reidentification of the package.

According to one embodiment, the method comprises the following step: once the package has been identified by comparison of the allocation dataset with the ident dataset, generating a position dataset relating to the current position of the package in the delivery vehicle. To this end, the current position of the package in the delivery vehicle is thus detected and allocated, for example in the cloud, to the identified package. The position dataset then encodes the position of the package in the delivery vehicle, for example in the form of a rack number and a position in the rack. The position dataset is then transmitted wirelessly from the cloud to the delivery vehicle and from there to a handset of the delivery agent or is transmitted directly from the cloud to the handset. The handset is configured to output the position dataset in text form and/or in the form of a voice message. In other words, the handset, based on the position dataset, assists the delivery agent in locating the package.

According to a further embodiment, the ident dataset and the allocation dataset are based on image data. This is data which have been obtained by means of one or more cameras, such as, for example, CMOS cameras, and are in each case converted into a machine-readable binary data string. They are thus suitable for machine processing.

According to a further embodiment, symbol data are additionally determined and analyzed by analysis of the reference image dataset and of the partial image dataset. The symbol data can on the one hand include the dimensions of the package. The symbol data can further also be data that are immediately understandable to the delivery agent, such as, for example, address labels with details concerning the recipient and/or the sender, or other details, such as, for example, that the package is to be handled with care because the contents are particularly fragile, or, for example, advertising labels of the sender, such as, for example, bands or parcel tape with symbols and/or trademarks of the sender. However, unlike the image data, the symbol data are not converted into a machine-readable form but remain in a format that is immediately understood by the delivery agent. In other words, the symbol data can be subjected to an OCR conversion so that, in addition to the encoded image data in machine-readable form, text data are also present, which are compared with one another. This simplifies and increases the reliability of the reidentification of the package.

The invention further includes a computer program product configured to carry out such a method, a system for operating such a delivery vehicle, and a delivery vehicle for such a system.

### BRIEF DESCRIPTION OF THE DRAWINGS

The invention will now be explained with reference to a drawing, in which:

FIG. 1 shows, in a schematic representation, components of a system for operating a delivery vehicle.

FIG. 2 shows, in a schematic representation, a load space of the delivery vehicle.

FIG. 3 shows further details of the analysis of image data.

FIG. 4 shows further details of the analysis of image data.

FIG. 5 shows further details of the analysis of image data.

FIG. 6 shows, in a schematic representation, a method sequence for operation of the system shown in FIG. 1.

### DETAILED DESCRIPTION

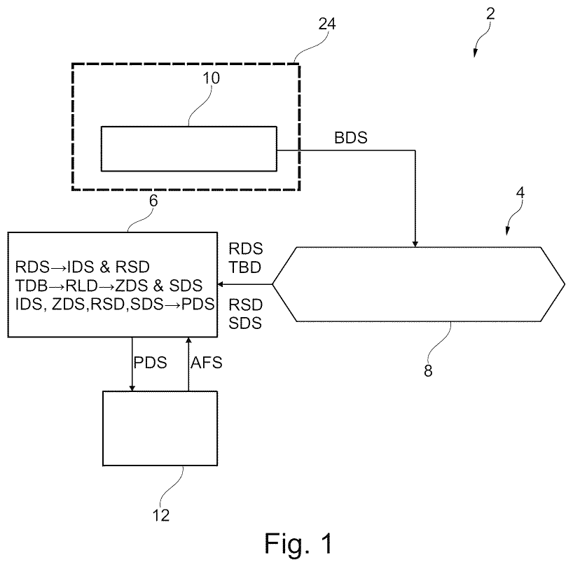

Reference will first be made to FIG. 1.

A system 2 for operating a delivery vehicle 4 is shown.

Of the components of the system 2, a cloud 6, a control unit 8, a distribution center camera array 10 and a handset 12 are shown in FIG. 1.

In the present exemplary embodiment, the cloud 6 is a high-performance computing center with high computing power and memory capacity. It serves as a memory and data processing unit of the system 2. In a departure from the present exemplary embodiment, the system 2 can comprise a plurality of sub-clouds, which are connected for data transmission to a central computing center. In a further departure from the present exemplary embodiment, a memory other than a cloud 6 can also be used.

In the present exemplary embodiment, the control unit 8 is an embedded system unit, which is located in the delivery vehicle 4. The control unit 8 has the necessary computing power and hardware elements (e.g. CPU, GPU, RAM, memory, CAN), is configured for wireless data transmission (4G, LTE, 5G) and has for that purpose corresponding interfaces (e.g. Ethernet interface, HDMI, USB, Wi-Fi).

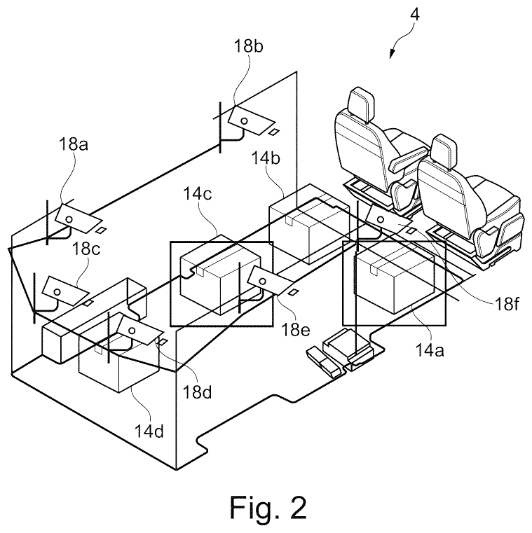

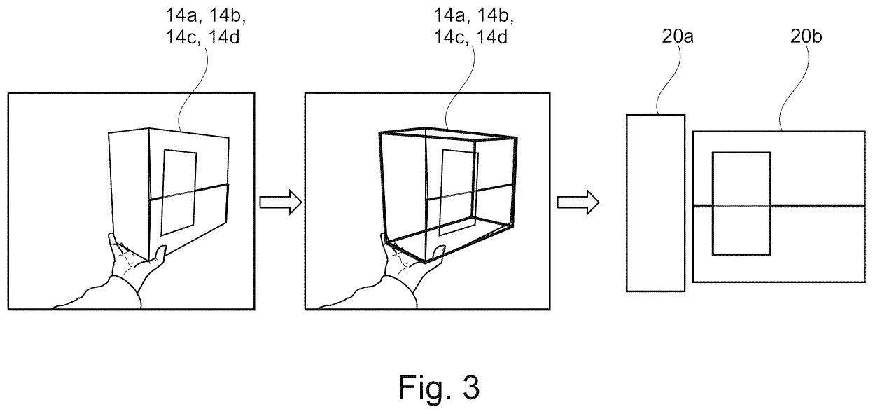

In the present exemplary embodiment, the distribution center camera array 10 in the distribution center 24 comprises a plurality of cameras, such as, for example, CMOS cameras, by means of which images of all the side faces 20a, 20b (see FIG. 3) of a package 14a, 14b, 14c, 14d (see FIGS. 2 and 3), that is to say of all six side faces 20a, 20b of a parcel having a cuboidal basic shape, are recorded in the distribution center 24 of a delivery service and are in each case stored temporarily as a reference image dataset RDS. For this purpose, the distribution center camera array 10 in the present exemplary embodiment has six cameras, one camera for each side face 20a, 20b. In a departure from the present exemplary embodiment, fewer cameras can also be used. A handling device for the package 14a, 14b, 14c, 14d can be associated with the distribution center camera array 10 in the distribution center 24, by means of which handling device the package 14a, 14b, 14c, 14d can be oriented for the recording of the images. Instead of CMOS cameras, IR cameras, stereo cameras or also LIDAR systems and combinations thereof can also be used.

The handset 12 is configured for human-computer interaction, wherein it is so small and lightweight that it can be held by a delivery agent with one hand. It has interfaces for wireless data transmission, for example with the control unit 8, and has a battery for supplying operating power. The handset 12 can be in the form of a mobile telephone, tablet, laptop or other portable device, for example also in the form of a barcode reader.

In a departure from the present exemplary embodiment, a different device or a device of the delivery vehicle 4, such as, for example, a light projector and/or activatable lamps on racks in the delivery vehicle 4, can also be provided for human-computer interaction instead of the handheld 12.

Reference will now additionally be made to FIG. 2.

A load space of the delivery vehicle 4 belonging to the system 2 is shown.

In the present exemplary embodiment, the delivery vehicle 4 is in the form of a delivery van, a land vehicle that does not run on rails. In a departure from the present exemplary embodiment, the delivery vehicle 4 can, however, be in the form of a land vehicle that runs on rails or also in the form of a watercraft or aircraft.

In the interior of the load space of the delivery vehicle 4 there is arranged a delivery vehicle camera array 16, like the distribution center camera array 10. In the present exemplary embodiment, the delivery vehicle camera array 16 comprises a plurality of cameras 18a, 18b, 18c, 18d, 18e, 18f, such as, for example, CMOS cameras, by means of which images of different side faces 20a, 20b of the packages 14a, 14b, 14c, 14d are recorded in the load space of the delivery vehicle 4 and stored temporarily as a partial image dataset TBD. Instead of CMOS cameras, IR cameras, stereo cameras or also LIDAR systems and combinations thereof can also be used.

For the described tasks and functions, the system 2 and its components can have correspondingly configured hardware and/or software components. The system 2 can further have for this purpose one or more artificial neural networks.

Artificial neural networks (ANN) have a plurality of artificial neurons, which in the case of deep neural networks arranged in many hidden layers between an input layer and an output layer. Recurrent neural networks (RNN) refer to neural networks which, in contrast to feedforward neural networks (FFN), are distinguished by connections of neurons of one layer to neurons of the same or a previous layer. Neurons of the same layer or of different layers are thus fed back.

In the present exemplary embodiment, training is affected by supervised learning. In a departure from the present exemplary embodiment, training can also be affected by unsupervised learning, reinforcement learning or stochastic learning.

During operation, during a first operating phase, the packages 14a, 14b, 14c, 14d are sorted in the distribution center 24 and combined into groups per delivery vehicle 4. Images of each side face 20a, 20b of the packages 14a, 14b, 14c, 14d are recorded to obtain image data. The image data then forms in each case a reference image dataset RDS. For each of these images, an ident dataset IDS is prepared by means of a deep learning algorithm, for example a trained Siamese neural network. The ident dataset IDS is a compression of the reference image dataset RDS, or of the images, wherein the ident dataset IDS is a machine-readable binary string and therefore cannot be interpreted by people.

A plurality of ident datasets IDS, for example, for each of the packages 14a, 14b, 14c, 14d form a gallery.

In addition, symbol data (cardboard box, trademark, label, adhesive tape) of the packages 14a, 14b, 14c, 14d are extracted from the reference image dataset RDS in the distribution center 24 and stored temporarily as a reference symbol dataset RSD, which later facilitates reidentification of the packages 14a, 14b, 14c, 14d, as is described in detail below.

During a second operating phase, a spatial location dataset RLD of the package 14a, 14b, 14c, 14d is determined for each package 14a, 14b, 14c, 14d during the loading and pick-up phase. For this purpose, a trained convolutional neural network (CNN) is used in the present exemplary embodiment. With the aid of the determined spatial location dataset RLD, the side faces 20a, 20b of the package 14a, 14b, 14c, 14d are extracted. The one, two or three, for example, side faces 20a, 20b in each case form a partial image dataset TBD, which is used to determine an allocation dataset ZDS by means of the same trained Siamese neural network.

In the present exemplary embodiment, a 3D enveloping body is next determined, with the aid of which each side face 20a, 20b of the package 14a, 14b, 14c, 14d is determined. An additional advantage is that the dimensions of the package 14a, 14b, 14c, 14d can thus be determined. This information assists with the reidentification of the package 14a, 14b, 14c, 14d. With the dimensions and eight vertices, the spatial location dataset RLD of the package 14a, 14b, 14c, 14d can be determined in the present exemplary embodiment by means of the PnP algorithm (Perspective n Point, see Li, Shiqi and Xu, Chi and Xie, Ming, A Robust O(n) Solution to the Perspective-n-Point Problem, 2012).

A trained convolutional neural network can be used for this purpose, which determines a midpoint of the package 14a, 14b, 14c, 14d and the 3D enveloping body as well as the eight corner points and the dimensions. It is able to detect a plurality of packages 14a, 14b, 14c, 14d and is robust in respect of masking, changes of the background, changing light conditions, etc. In the present exemplary embodiment, CenterPose (see Yunzhi Lin and Jonathan Tremblay and Stephen Tyree and Patricio A. Vela and Stan Birchfield, Single-stage Keypoint-based Category-level Object Pose Estimation from an RGB image, 2021) would be used for this purpose.

Reference will additionally be made to FIG. 3.

After the spatial location dataset RLD has been determined, each side face 20a, 20b of the package 14a, 14b, 14c, 14d is extracted and warped into a rectangle on the basis of the width and height of the package 14a, 14b, 14c, 14d. In the present exemplary embodiment, an open-source tool which uses the opencv integrated function “WarpPerspective” is used for this purpose.

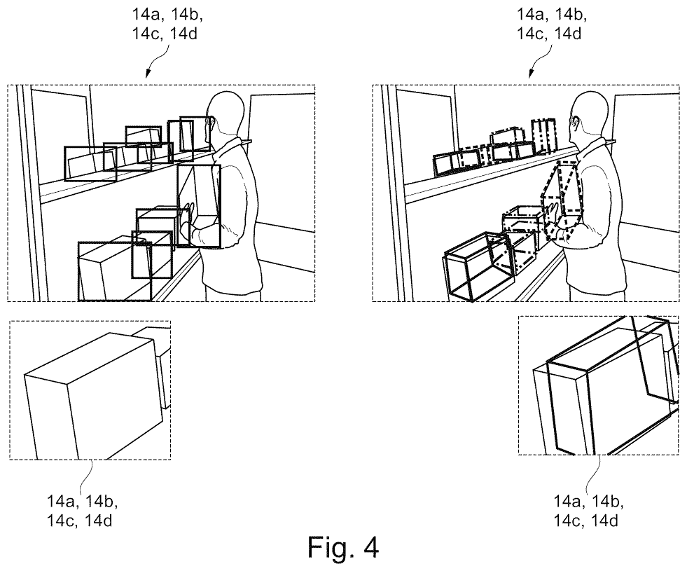

Reference will now be made to FIG. 4.

The reference image dataset RDS and the partial image dataset TBD are further analyzed to extract the symbol data and form the reference symbol dataset RSD on the basis of the reference image dataset RDS and the symbol dataset SDS on the basis of the partial image data set TBD.

With the aid of intelligent alignment techniques, the allocation dataset ZDS and the ident dataset IDS as well as the reference symbol dataset RSD and the symbol dataset SDS are analyzed to identify the packages 14a, 14b, 14c, 14d.

There can be used for this purpose a deep learning algorithm, for example a trained neural feedforward network, to which the allocation dataset ZDS and the ident dataset IDS are fed on the input side, and which provides the allocation dataset ZDS on the output side.

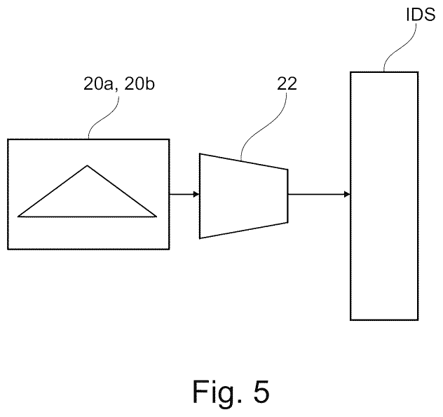

It is also possible to use a static based algorithm or a deterministic algorithm, which examines a maximum interference of combined probabilities of image data and symbol data. Thus, for example, a product of probabilities which are associated with the similarity between the image data of a plurality of side faces 20a, 20b and symbol data is compared. Reference will now additionally be made to FIG. 5.

In the present exemplary embodiment, there is used for the reidentification of the packages 14a, 14b, 14c, 14d a further trained neural network 22, which converts the image of a side face 20a, 20b, that is to say the reference image dataset RDS, into the ident dataset IDS (see Zheng, Zhedong and Zheng, Liang and Yang, Yi, A Discriminatively Learned CNN Embedding for Person Reidentification, 2018) and uses neural networks having a backbone architecture, such as, for example, ResNet or MobileNet, to extract features. The artificial neural network 22 delivers on the output side as the output an output vector with a vector size of 128 nodes. In a departure from the present exemplary embodiment, the vector size of the output vector can also be different and have, for example, another value with a power of 2, such as, for example, 1024, in order that the output vector has a sufficient information content for the reidentification.

The output vector contains all the important visual information of the side face 20a, 20b of the packages 14a, 14b, 14c, 14d. Images which represent the same side face 20a, 20b of the packages 14a, 14b, 14c, 14d should result in similar ident datasets IDS. By contrast, images which represent different packages 14a, 14b, 14c, 14d should result in very different ident datasets IDS.

The similarity of ident datasets IDS can be determined with the aid of standard distance metrics (such as, for example, cosine similarity or Euclidean distance). By means of such a metrics, the gallery can be searched to determine the allocation dataset ZDS that best matches.

In the present exemplary embodiment, it is provided that symbol data, which are determined by analysis of the reference image dataset RDS and of the partial image dataset TBD, are additionally used in order thus to obtain additional data. For this purpose, there is used in the present exemplary embodiment a trained neural network, which provides symbol data for each side face 20a, 20b, to limit the search space. If, for example, a packaging logo, a barcode, a label, a color, a band, a shape or a trademark can be determined, the search space can be limited to only those packages 14a, 14b, 14c, 14d that are relevant.

In the present exemplary embodiment, Yolo is used for this purpose, but other tools, such as, for example, Faster R-CNN, can also be used.

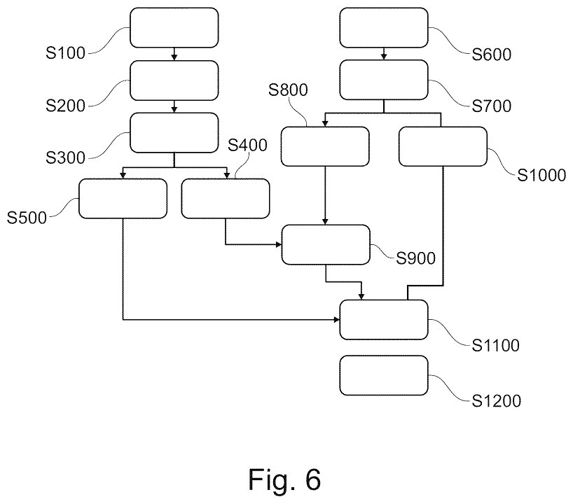

A method sequence for operation of the system 2 will now be explained with additional reference to FIG. 6.

In a preliminary step, during a training phase, the neural networks mentioned hitherto are trained with training data, in the present exemplary embodiment by means of supervised learning. In the present exemplary embodiment, a plurality of 725 images of packages 14a, 14b, 14c, 14d, all of which had a uniform green image background, was used as the base. In order to expand the base, the image background was varied, that is to say the green background was replaced by a random background.

In a first step S100, the packages 14a, 14b, 14c, 14d are sorted in the distribution center 24.

In a further step S200, the packages 14a, 14b, 14c, 14d for the delivery vehicle 4 are combined into groups.

In a further step S300, the reference image dataset RDS of the package 14a, 14b, 14c, 14d is generated.

In a further step S400, the reference image dataset RDS is analyzed to determine the ident dataset IDS for the package 14a, 14b, 14c, 14d, and the ident dataset IDS is stored temporarily in the cloud 6.

In a further step S500, the symbol data of the reference image dataset RDS are extracted.

In a further step, the packages 14a, 14b, 14c, 14d are loaded into the delivery vehicle 4.

In a further step S600, the spatial location dataset RLD of the package 14a, 14b, 14c, 14d is determined.

In a further step S700, the side faces 20a, 20b of the package 14a, 14b, 14c, 14d are determined.

In a further step S800, the partial image dataset TBD of the package 14a, 14b, 14c, 14d in the delivery vehicle 4 is generated in the cloud 6.

In a further step S900, the partial image dataset TBD is evaluated in response to a request signal AFS, for example from the delivery agent, to determine the allocation dataset ZDS for the package 14a, 14b, 14c, 14d.

In a further step S1000, the partial image dataset TBD is evaluated to extract the symbol data.

In a further step S1100, the allocation dataset ZDS and the ident dataset IDS and the reference symbol dataset RSD and the symbol dataset SDS are compared with one another to identify the package 14a, 14b, 14c, 14d.

In a further step S1200, the position dataset PDS relating to the current position of the package 14a, 14b, 14c, 14d in the delivery vehicle 4 is generated and transmitted to the handset 12 or another output device, which subsequently provides a corresponding sound and/or image output in order to inform the delivery agent of the current position of the package 14a, 14b, 14c, 14d.

In a departure from the present exemplary embodiment, the sequence of steps can also be different. In addition, a plurality of steps can also be carried out at the same time, or simultaneously. Furthermore, in a departure from the present exemplary embodiment, individual steps can also be skipped or omitted.

The method allows the package in question 14a, 14b, 14c, 14d to be reidentified based on the reference image dataset RDS by comparison with a partial image dataset TBD. In other words, use is made of the fact that only part of the data that were used for the initial identification is necessary for reidentification of the package 14a, 14b, 14c, 14d.

### LIST OF REFERENCE SIGNS

2 System
4 Delivery vehicle
6 Cloud
8 Control unit
10 Distribution center camera array
12 Handset
14a Package
14b Package
14c Package
14d Package
16 Delivery vehicle camera array
18a Camera
18b Camera
18c Camera
18d Camera
18e Camera
18f Camera
20a Side face
20b Side face
22 Neural network
24 Distribution center
AFS Request signal
IDS Ident dataset
PDS Position dataset
RDS Reference image dataset
RLD Spatial location dataset
RSD Reference symbol dataset
SDS Symbol dataset
TBD Partial image dataset
ZDS Allocation dataset
S100 Step
S200 Step
S300 Step
S400 Step
S500 Step
S600 Step
S700 Step
S800 Step
S900 Step
S1000 Step
S1100 Step
S1200 Step

What is claimed is:

1. A method for operating a delivery vehicle, comprising the steps:
generating a reference image dataset of a package;
analyzing the reference image dataset to determine an ident dataset for the package, and temporarily storing the ident dataset;
generating a partial image dataset of the package in the delivery vehicle;
determining a spatial location dataset that is indicative of a spatial location of the package;
analyzing at least the partial image dataset using the spatial location dataset to determine an allocation dataset for the package; and
comparing the allocation dataset with the ident dataset to reidentify the package.

2. The method according to claim 1, further comprising the step:
identifying the package and, upon identification, generating a position dataset relating to the current position of the package in the delivery vehicle.

3. The method according to claim 1, wherein the ident dataset and the allocation dataset are based on image data.

4. The method according to one of claim 1, further comprising determining symbol data, and analyzing the symbol data by analysis of the reference image dataset and of the partial image dataset.

5. A system for operating a delivery vehicle, wherein the system is configured to generate a reference image dataset of a package, comprising:
analyze the reference image dataset to determine an ident dataset for the package and to temporarily store the ident dataset;
generate a partial image dataset of the package in the delivery vehicle;
determine a spatial location dataset that is indicative of a spatial location of the package;
analyze at least the partial image dataset using the spatial location dataset;
determine an allocation dataset for the package; and
compare the allocation dataset with the ident dataset to reidentify the package.

6. The system according to claim 5, wherein the system is configured, once the package has been identified, to generate a position dataset relating to the current position of the package in the delivery vehicle.

7. The system according to claim 5, wherein the ident dataset and the allocation dataset are based on image data.

8. The system according to claim 5, wherein symbol data is additionally determined and analyzed by analysis of the reference image dataset and of the partial image dataset.

9. The system according to claim 5, where the reference image dataset includes images of all sides of the package.

10. A vehicle, comprising:
one or more processors; and
memory storing executable instructions that, as a result of execution by the one or more processors, cause the system to:
generate a reference image dataset of a package;
analyze the reference image dataset to determine an ident dataset for the package, and temporarily storing the ident dataset;
generate a partial image dataset of the package in the delivery vehicle;
determine a spatial location dataset that is indicative of a spatial location of the package;
analyze the partial image dataset using the spatial location dataset to determine an allocation dataset for the package; and
compare the allocation dataset with the ident dataset to reidentify the package.

11. The vehicle according to claim 10, wherein the system is configured, once the package has been identified, to generate a position dataset relating to the current position of the package in the delivery vehicle.

12. The vehicle according to claim 10, wherein the ident dataset and the allocation dataset are based on image data.

13. The vehicle according to claim 10, wherein symbol data is additionally determined and analyzed by analysis of the reference image dataset and of the partial image dataset.

14. The vehicle according to claim 10, where the reference image dataset includes an image of each side of the package.

15. The vehicle of claim 10, further comprising transmitting the spatial location of the package to a handset associated with the vehicle.
